(19) United States
(12) Patent Application Publication
(10) Pub. No.: US 2015/0086273 A1
(43) Pub. Date: Mar. 26, 2015

(54) METHOD OF INSTALLING A PIPELINE AND PIPELINE SUPPORT SYSTEM

(71) Applicant: Scott E. Forse, Venetia, PA (US)

(72) Inventor: Scott E. Forse, Venetia, PA (US)

(21) Appl. No.: 14/283,305

(22) Filed: May 21, 2014

Related U.S. Application Data
(60) Provisional application No. 61/882,699, filed on Sep. 26, 2013.

(51) Int. Cl. F16L 3/02; F16L 3/00; F16L 1/036

(52) U.S. Cl. CPC F16L 3/02; F16L 1/036; F16L 3/00
USPC 405/157

(57) ABSTRACT

A method is disclosed for installing a pipeline made up of a plurality of pipe lengths or sections to extend along a predetermined underground grade in a trench. Pillow blocks are secured to the underside of the pipe lengths at predetermined intervals and the pipe lengths are respectively lifted with the pillow blocks suspended thereunder and sequentially placed in the trench with the blocks positioned thereunder on the grade surface in the trench. The pipe sections are then secured together to form a pipeline and the trench is backfilled. The pillow blocks may be adhered to the underside of the pipe sections or the pillow blocks may be loosely secured to the underside of the pipe lengths whereby the blocks will maintain a position by force of gravity under the respective pipe sections to which they are attached when the respective pipe sections are suspended in the air above ground.

### CROSS REFERENCE

This application claims the benefit of U.S. Provisional Patent Application No. 61/882,699, filed on 26 Sep. 2013, for PIPELINE SUPPORT PILLOW BLOCKS AND METHOD OF PIPELINE INSTALLATION, the contents of which are incorporated herein by reference.

### BACKGROUND OF THE INVENTION

The present invention relates to an improved pipeline support and protection system for pipelines installed in a trench.

When in-ground pipelines are laid, a trench for the pipeline is excavated and before the pipeline is laid into the trench, a bed of cushioning material must first be laid in the bottom of the trench in order to protect the pipeline from nicks and abrasions from surrounding rock in the trench. If the pipe is nicked or abraded, this sets up conditions for corrosion occurring on the pipe which causes early failure.

For the cushioning material, the most popular method is to line the bottom of the trench with sandbags. The sandbags weigh approximately 40 pounds apiece and they must be laid in the trench with an approximate spacing of 15 feet between sandbags.

The sandbags are labor intensive to fill and to lay them in the trench. The workers are not permitted to physically enter the trench in order to properly position the sandbags due to OSHA standards. Accordingly, the bags must be dropped into the trench by hand and they often do not position correctly.

The weight of the sandbags themselves is a factor in delaying the pipeline installation. The sandbags weigh 40 pounds apiece and approximately 16,000 sandbags are required for the installation of each mile of pipeline.

Another prior art method for installing the cushioning material for the pipeline is the blowing of self rising and expanding foam into the bottom of the trench. However, this method is excessively expensive.

### SUMMARY OF THE INVENTION

The present invention provides a method of installing a pipeline made up of a plurality of pipe lengths or sections which are designed to extend along a predetermined underground grade. A trench for the pipeline is dug to expose the desired underground grade and light weight pillow blocks are then secured to the underside of the pipe sections at predetermined intervals. The pipe sections, together with their attached pillow blocks suspended thereunder are sequently lifted and placed in the trench with the blocks positioned thereunder and resting on the grade surface. The pipe sections in the trench are then secured together to form a pipeline and the trench is backfilled.

In one embodiment the pillow blocks are adhered to the bottom of the pipe sections, and in a different embodiment the pillow blocks are loosely secured to the underside of the pipe lengths whereby the blocks will maintain a position by force of gravity under the respective pipe sections to which they are attached when the respective pipe sections are suspended in air above ground. In the latter embodiment the pillow blocks are preferably independently secured to the pipe sections with flexible non-metal ties.

The pillow blocks are formed of a plastic foam, such as cellular polyurethane which is cut to a desired shape. If desired, the pillow blocks may be covered with a liquid impermeable fabric, such as an HDPE coated fabric, which may be provided with a bright highly visible color for safety purposes.

The upper surface of each of the pillow blocks may be provided with a recessed saddle surface for more suitably seating the respective pipe sections and thereby maintaining the pipe sections centered on the pillow blocks.

### BRIEF DESCRIPTION OF THE DRAWINGS

Other objects and advantages appear hereinafter in the following description and claims. The accompanying drawings show, for the purpose of exemplification, without limiting the scope of the invention or the appended claims, certain practical embodiments of the invention wherein:

FIG. 1 is a perspective view of one embodiment of the pillow blocks of the present invention secured to and retained under a suspended pipeline section with flexible ties;

FIG. 2 is a perspective view of a pipeline laid in a trench and supported at intervals with the support pillow blocks of the present invention; and

FIG. 3 is a perspective front view of a support pillow block of the present invention without the inclusion of the flexible ties or a covering.

### DETAILED DESCRIPTION OF A PREFERRED EMBODIMENT

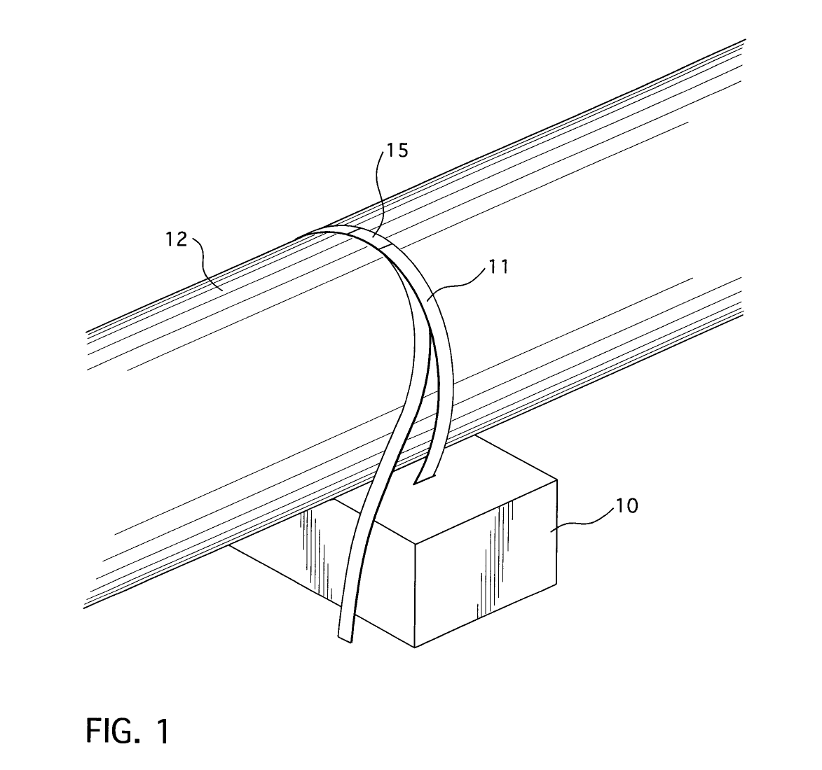

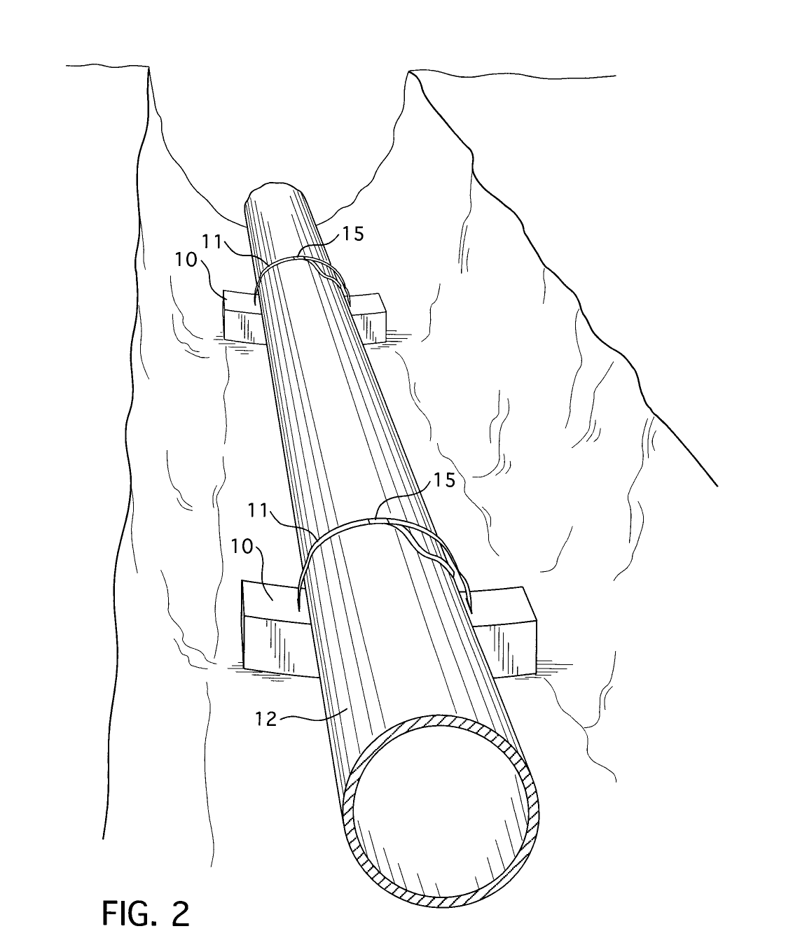

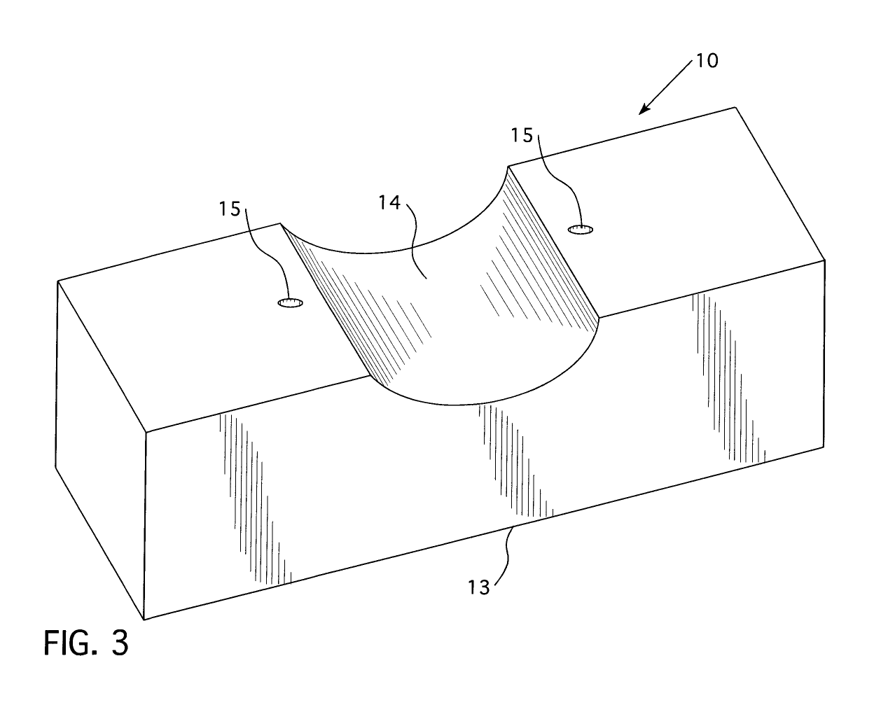

Referring to FIGS. 1 and 2, the support pillow block 10 of the present invention is a cut block of cellular polyurethane secured by ties 11 to pipeline 12. In FIGS. 1 and 2 the pillow blocks 10 are covered with a brightly colored liquid-impermeable HDPE coated woven liner. However, the inclusion of this liner wrap is not absolutely necessary or critical. Bare foam block 10 as illustrated in FIG. 3 may be utilized as shown in FIG. 1 without a covering.

Note in FIG. 3 that the pillow block 10 is provided with a saddle 14 on its top surface to fit the underside contours of the pipeline section 12 which serves to hold the pipeline section in the middle of the blocks 10. The block 10 is also provided with spaced through passages 15 for the passage and securement of flexible ties 11. Ties 11 may be loosely applied to pipeline 12 so that the blocks 10 are encouraged to freely swing or slide to a bottom position by gravity. The ties 11 must be flexible and nonmetallic so that no reaction or abrasion occurs with the pipeline section. The nonmetallic ties 11 may be secured together about the pipe sections 12 as indicated at 15 in FIG. 1 by merely tying ends together or by using a hook and loop securement, such as Velcro™ or by using a nonmetallic plastic buckle.

The blocks 10 are specifically designed to conform to the uneven ground or grade below the pipe within the ditch or trench, while providing structural stability needed to bridge and hold the weight of the pipe. The pipe section is thus well cushioned from the abrasive ground surface.

Any suitable resilient light weight foam material may be substituted for the cellular polyurethane utilized for pillow block 10, provided that it provides a stiff resilience for adequate cushioning support of the pipeline sections 12. For heavier pipeline sections, the blocks 10 may be manufactured of the same foam product but with a greater density. In actual tests, cellular polyurethane pillow blocks 10 were manufactured with a compression strength of 3,500 pounds. Two of these more dense pillow blocks 10 will support a 24″ by 45′ pipe section that weighs 7,000 pounds with a deflection that is less than 1½″.

In addition, other non-abrasive methods of securement may be utilized in place of ties 11, such as an adhesive.

It may be accordingly observed that the problems of the prior art are thus eliminated. The support pillow blocks 10 of the present invention are extremely light weight and therefore easy to transport and apply, and they are relatively inexpensive to manufacture. The worker does not have to enter the pipeline trench and the blocks 10 are easily applied at spaced intervals to the suspended pipeline section before it is lowered into the trench. Each block 10 weighs less than 4 pounds and will take the place of 40 pound sandbags currently used to protect the pipe from rocks underneath the pipe sections. The blocks 10 of the present invention are equal to six well placed sandbags. A 2.5 pound pillow block 10 of the present invention replaces 6 sandbags weighing 240 pounds. Thus there is no need for an on-site sandbag filling machine or heavy totes. This reduces personal injury to workers and further reduces the number of workers required at the job site.

At a 15′ spacing, using 353 pillow blocks 10 per mile of pipeline, the labor and cost saved is that which would otherwise be associated with the placement of 2,118 sandbags required to accomplish the same task.

I claim:

1. A method of installing a pipeline, made up of a plurality of pipe sections, to extend along a predetermined underground grade, the method comprising:
digging a trench to expose the desired underground grade;
securing pillow blocks to the underside of said pipe lengths at predetermined intervals;
respectively lifting said pipe sections with said blocks suspended thereunder and sequentially placing the suspended pipe sections in said trench with said blocks positioned thereunder on said grade;
securing said pipe sections in said trench together to form a pipeline; and
backfilling said trench.

2. The method of claim 1, wherein said pillow blocks are loosely secured to the underside of said pipe lengths whereby said blocks are encouraged to maintain a position by force of gravity under the respective pipe sections to which they are attached when the respective pipe sections are suspended in the air above ground.

3. The method of claim 2, wherein said pillow blocks are independently secured to said pipe sections with flexible nonmetallic ties.

4. The method of claim 2, wherein said pillow blocks are formed of plastic foam.

5. The method of claim 4, wherein said pillow blocks are formed of cellular polyurethane cut to a desired shape.

6. The method of claim 5, wherein said pillow blocks are covered with a liquid impermeable fabric.

7. The method of claim 6, wherein said fabric is selected as an HDPE coated fabric.

8. The method of claim 7, wherein said fabric is selected to have a bright color.

9. The method of claim 4, wherein an upper surface of each of said pillow blocks is provided with a saddle surface for seating said pipe sections.

10. The method of claim 1, wherein said pillow blocks are adhered to the bottom of said pipe sections.

11. The method of claim 10, wherein said pillow blocks are formed of plastic foam.

12. The method of claim 11, wherein said pillow blocks are formed of cellular polyurethane cut to a desired shape.

13. The method of claim 12, wherein said pillow blocks are covered with a liquid impermeable fabric.

14. The method of claim 13, wherein said fabric is selected as an HDPE coated fabric.

15. The method of claim 11, wherein an upper surface of each of said pillow blocks is provided with a saddle surface for seating said pipe sections.

16. A pipeline support system comprising:
a series of spaced plastic foam pillow blocks secured to the underside of a pipeline to be supported on a ground surface.

17. The pipeline support system of claim 16, wherein said pillow blocks are cellular polyurethane.

18. The pipeline support system of claim 16, wherein said pillow blocks are secured to said pipeline with flexible nonmetallic ties.

19. The pipeline support system of claim 16, wherein said pillow blocks have a saddle surface for seating said pipeline.

20. The pipeline support system of claim 16, wherein said pillow blocks are adhered to underside of said pipeline.
